(19) United States
(12) Patent Application Publication
(10) Pub. No.: US 2002/0010803 A1
(43) Pub. Date: Jan. 24, 2002

(54) Method, system and apparatus for establishing, monitoring, and managing connectivity for communication among heterogeneous systems

(76) Inventors: Brien M. Oberstein, New York, NY (US); Robert L. Peacock, Brooklyn, NY (US); Samuel R. Johnson, New York, NY (US); David J. Josse, New York, NY (US)

Correspondence Address: MORGAN & FINNEGAN, L.L.P., 345 Park Avenue, New York, NY, 10154-0053, US

(21) Appl. No.: 09/864,655

(22) Filed: May 24, 2001

Related U.S. Application Data
(60) Provisional application No. 60/207,091, filed on May 25, 2000.

(51) Int. Cl. G06F 9/46

(52) U.S. Cl. 709/318

(57) ABSTRACT

A method, system and apparatus for establishing, monitoring and managing connectivity for communication among heterogeneous systems, such as in client-server networks having a plurality of systems, wherein the client-server network comprises a server for processing incoming events, an agent resident on at least one of the plurality of networks, and a monitor coupled to the agent, where the monitor handles and displays notifications and enables event handling. The agent remains in communication with the server to facilitate monitoring and error handling by one or more systems connected to the server. The server acts as a message router for forwarding events between one or more agents, and the server further stores events and event actions that flow through the system. Directory services facilitate querying and publishing to a repository or repositories of information to assist counter-parties in establishing connectivity directly with each other.

### CROSS-REFERENCE TO RELATED APPLICATION

This application claims priority from provisional U.S. patent application Ser. No. 60/207,091 entitled METHOD AND SYSTEM FOR DISCOVERING, ESTABLISHING AND MANAGING NETWORK CONNECTIVITY, filed in the name of Samuel R. Johnson on May 25, 2000, the entirety of which is incorporated by reference herein.

### FIELD

A method, system and apparatus for establishing, monitoring, and managing connectivity for communication among heterogeneous systems, and more particularly directed to a method, system and apparatus for monitoring events generated in various systems, and managing connectivity across the heterogeneous systems.

### BACKGROUND

From financial services, to the automotive industry, to travel, to healthcare and retailing, industries are aggressively seeking ways to better communicate and transact business by creating various forms of electronic marketplaces. Some, like the automotive industry, have tried building new and centralized electronic exchanges in the hopes of bringing together suppliers and purchasers for optimizing trade. In others, suppliers and purchasers have used the web to provide business partners direct access to proprietary ordering or inventory systems.

In more technologically complex and information-sensitive industries, people are seeking efficient ways of establishing, managing, and monitoring direct connections between companies or business partners, using public or private networks and mutually agreed standard protocols and interfaces. While this type of connectivity is significantly more difficult to achieve, it is preferred over the alternatives mentioned above. For example, when a company is able to connect its internal systems directly with those of its business partners, it suddenly has the ability to conduct business immediately, cheaply, and without compromising the confidentiality of the transaction.

Direct, peer-to-peer connectivity for transacting business is regarded by many as a sort of ‘holy grail’ due to its inherent challenges in implementation. Some of the challenges include defining and agreeing upon interfaces, testing for compatibility between new peer connections, and managing and supporting the peer network as a whole. In other words, complex business-level interfaces, conflicting standards for connectivity, and networks lacking centralized management (e.g. the Internet) all combine to create significant challenges for companies hoping to establish large-scale peer-to-peer connectivity with their business partners.

Unfortunately, achieving real scalability in a peer network requires both a reliable mechanism for ensuring that interfaces are compatible between peers and an appropriate infrastructure for monitoring and troubleshooting network links at each layer of communication during all hours. Monitoring and supporting these links can be particularly troublesome because many of the networks used to connect companies or entities are not centrally managed. In the case where businesses are building peer interfaces on open standards and multiple networks are available for establishing links, the problem is compounded because a company's peer connections might span multiple networks, all with different support infrastructures and varying levels of interoperability. An entity's internal systems and applications may be protected by a firewall or similar device that prevents access from outside the entity. Furthermore, parties who want to transact business with other parties on a direct, peer-to-peer level face the initial hurdle of simply gathering business, session, and application level information about potential counterparties.

Furthermore, where the technology at both ends of the link and the network in between are not owned and/or managed by a single vendor, monitoring of the connection and the status of information passing through the connection becomes difficult. This problem gets compounded with the introduction of each new interface protocol, private network, and vendor application.

Thus, there is a need for a mechanism to monitor existing peer-to-peer connections and networks, where the peers' applications, systems, and/or networks may be incompatible or inaccessible with other peer networks. Further, there is a need for a mechanism to discover connectivity and transactional information across heterogeneous networks. There is an additional need for a mechanism to establish dynamic network connectivity across heterogeneous networks. In addition, there is a need for a method, system and apparatus for managing network connectivity across networks which may be disparate, between different entities and among complex applications.

### SUMMARY

The method, system and apparatus for establishing, monitoring and managing connectivity for communication among heterogeneous systems disclosed herein overcomes the above-mentioned disadvantages.

The method, system and apparatus for establishing, monitoring and managing connectivity for communication among heterogeneous systems provides a monitoring architecture for all interactions between one or more systems at all levels, regardless of whether the systems are disparate, and regardless of where the systems are located. The method, system and apparatus for establishing, monitoring and managing connectivity for communication among heterogeneous systems is capable of providing a monitoring architecture at each layer within each system, regardless of the layer's specific implementations or characteristics, such as the communications interface layer, the transaction processing layer, and the business layer. Furthermore, the invention can monitor any and all information that may affect a transaction or connection, including, for example, whether the connection is functioning properly, the rate at which information is flowing between the systems, and whether information is being processed correctly at the business layer.

According to one embodiment, the system is a client-server architecture that comprises a server, a client (i.e., an agent) resident on at least one of a plurality of networks, and a monitor coupled to the agent, where the monitor handles and displays notifications and controls and manages event processing. The agent remains in communication with the server to facilitate monitoring, discovering, and managing network connectivity, and error handling by one or more agents connected to the server. In one embodiment, the server can also act as a message router for forwarding events between one or more agents. The server can also act as a repository for persisting events and for processing rules to be used by the agents. The server can maintain information on all agents and the functions being performed by the agents. The server also can act as a “virtual agent” for a system that does not have an integrated agent component, whereby the server acts as both the server and the agent.

The server framework is comprised of an event manager that continuously listens for events, a server workflow engine for processing events received within the system, a server workflow manager for controlling priority of events and overseeing the processing of events by the workflow engine, a state manager for maintaining state of the events across the workflow engine, and a notification dispatcher for transmitting event notifications via various delivery transports. The server also provides a repository for the events flowing in the system, and rules used in agent and server event processing.

The agent framework is comprised of an event manager that continuously listens for events, a workflow engine for processing events received within the system, a workflow manager for controlling priority of events and overseeing the processing of events by the workflow engine, a state manager for maintaining state of the events across the workflow engine, and a notification dispatcher for transmitting event notifications via various delivery transports. The agent further comprises an Application Program Interface (API) for interfacing with external event-generating entities to receive events addressed to the agent.

According to one embodiment, the monitor displays events and event logs in the system and handles subsequent event notifications. The monitor provides a customization mechanism for event handling. The monitor may be viewed from a standard web browser. An API may also be provided in order for an application to interface to the agent for events and event notifications.

These aspects and other objects, features, and advantages of the method, system and apparatus for establishing, monitoring and managing connectivity for communication among heterogeneous systems are described in the following Detailed Description, which is to be read in conjunction with the accompanying figures and the claims.

### BRIEF DESCRIPTION OF THE FIGURES

FIG. 1 provides a illustration of an embodiment of the model for a method, system and apparatus for establishing, monitoring and managing connectivity for communication among heterogeneous systems;

FIG. 2 provides an overview of an embodiment of the agent for use within the system of FIG. 1;

FIG. 3 provides an overview of an embodiment of the server for use within the system of FIG. 1;

FIG. 4 is a flow diagram of exemplary actions taken by the agent of FIG. 2;

FIG. 5 is a flow diagram of exemplary actions taken by the server of FIG. 3; and

FIGS. 6A-B are flow diagrams of an embodiment of the monitor for use within the system of FIG. 1.

With reference to the following detailed description, the aforementioned Figures will be described in greater detail below.

### DETAILED DESCRIPTION

Described herein is a method, system and apparatus for establishing, monitoring and managing connectivity for communication among heterogeneous systems.

The method, system and apparatus for establishing, monitoring and managing connectivity for communication among heterogeneous systems is not limited to a transaction routing network or messaging hub, but instead provides a framework for extending an existing network monitoring solution with intelligence about all points of failure in a meta-network. According to one embodiment, the system is a platform for defining customer-specific notifications for immediate escalation of connectivity or other problems to appropriate people and systems, regardless of where they might be.

At a high level, the system comprises a network that includes a server, a client (i.e., an agent) resident on at least one of the networks, and a monitor coupled to the agent, where the monitor displays events and handles event notifications, controls and manages event processing. The agent remains in communication with the server to facilitate establishing, monitoring and managing network connectivity, and to allow error handling by one or more agents connected to the server. In one embodiment, the server can act as a message router for forwarding events between one or more agents. The server can also act as a repository for persisting events and for processing rules to be used by the agents. According to one embodiment, the server may interface to a directory service that maintains system information and preferences. In one embodiment, transport preferences (e.g., electronic mail (e-mail), paging, web browsing, instant messaging, etc) for event notifications are contained within the directory service.

According to one embodiment, a system or any peer network does not have an agent. In this embodiment, the server acts as a virtual agent, whereby the processing occurs solely on the server. Events may propagate up to the server directly through an event API, or propagate indirectly through another party's(ies') (i.e., counter-party) agent that in turn passes the events up to the server. Event handling scripts are retrieved from the directory service and the workflow processes the events.

According to one embodiment, the system has an agent that listens for system exceptions between different networks, sessions, and/or applications which may or may not be disparate. For example, the agent can detect a connection failure between two networks. In this example, the agent detects the connection failure, generates an event, and processes the event. The system then notifies the appropriate parties regarding the caused failure. At the same time, the server may also generate separate notifications to the appropriate contact people within each counter-party to the connection, informing the counter-party that a problem has been detected and that the appropriate personnel need to be notified. For example, in the situation where a gateway fails, one of the courses of action may be to notify the first-line support personnel within the underlying organization that hosts the gateway and then to escalate the monitoring alert event by alerting someone else if that first alert message is not acknowledged in a timely manner.

With reference to the Figures, various embodiments of the method, system and apparatus for establishing, monitoring and managing connectivity for communication among heterogeneous systems will now be described in greater detail. It is to be understood that the tasks shown in the Figures and described in this Detailed Description can be sequenced in many different orders to achieve the desired result. The order or sequence of tasks illustrated in the Figures is merely intended to be exemplary of the concepts defined herein.

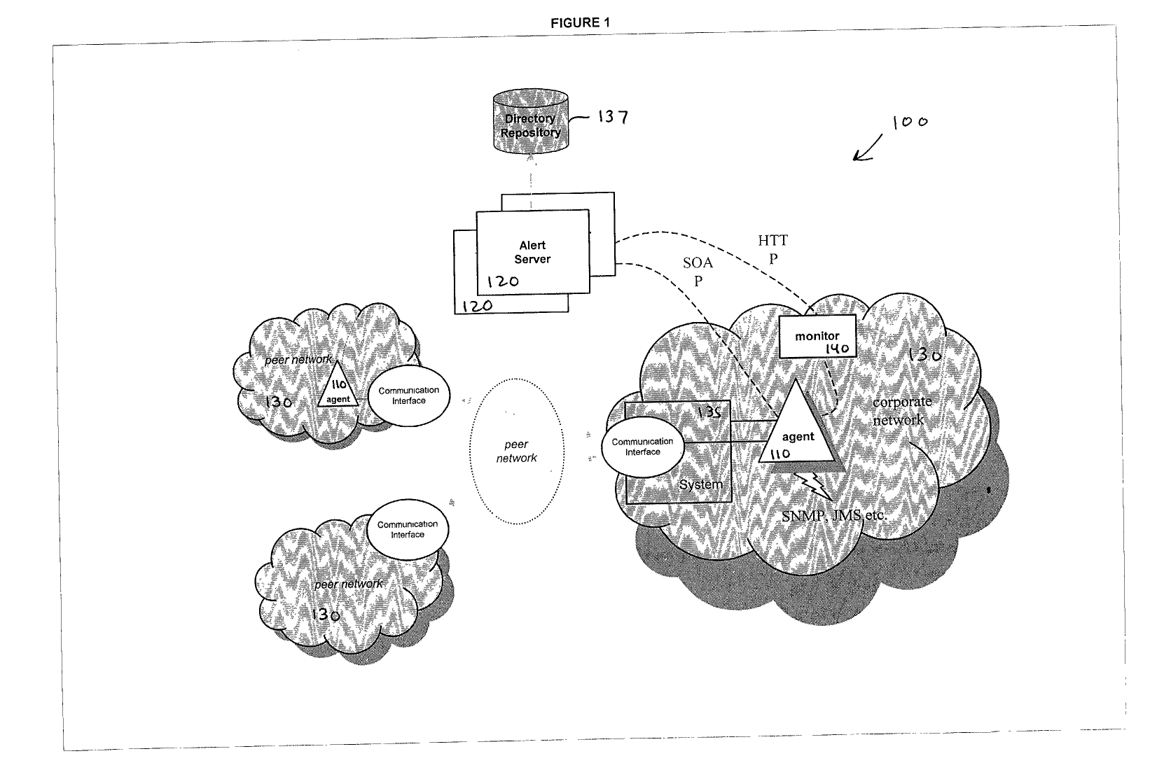

FIG. 1 illustrates the method, system and apparatus for establishing, monitoring and managing connectivity for communication among heterogeneous systems, and interactions between them. In particular, the system 100 comprises two main components: agent(s) 110 and server 120. Agent 110 and server 120 communicate with each other about monitoring information over any of various transport protocols, such as the Simple Object Access Protocol (SOAP) open standard. SOAP's underlying transport can be HyperText Transfer Protocol (HTTP), which is typically allowed through corporate firewalls, thereby freely allowing the passage of alert messaging through systems. SOAP defines the use of Extensible Markup Language (XML) and HTTP to access services, objects, and servers in a platform-independent manner. A detailed description of SOAP is provided in an article by Aaron Skonnard, entitled “SOAP: The Simple Object Access Protocol,” Microsoft Internet Developer, January 2000.

One important aspect of the invention is that the introduction of a method, system and apparatus for establishing, monitoring and managing connectivity for communication among heterogeneous systems does not change or depend on the characteristics or any other features of the peer-to-peer network 130, the event-generating entities 135, or the applications that are being monitored. According to one embodiment, automated and systematic notifications are provided to interested parties as a result of alert events generated within the network, without any active intervention from the server 120.

The agent 110 is at least one process running locally inside an organization and communicating with internal applications and processes. In other words, the agent 110 is the client in the client-server architecture designated as the system 100. The server 120, on the other hand, is an application service running in a central hosted facility that communicates with the various agents 110, and also acts as a repository of events passing through the system 100 and/or rules needed for processing the events.

The server also may interface with a number of directory services 137. Directory services 137 facilitate querying and publishing to a repository or repositories of information to assist different networks 130 in establishing connectivity directly with each other. Directory services 137 are based on standard industry protocols such as Lightweight Directory Access Protocol (LDAP), Universal Description, Discovery, and Integration (UDDI), customized SOAP-based directory services and/or the like. Directory services 137 provide information that assists with the discovery of potential counter-parties, the products and markets in which they trade or do business, the protocol and/or system interfaces they support, and any other information necessary for defining, handling and/or processing events in the system 100.

The system 100 also comprises a monitor 140 that is coupled to agent 110. Monitor 140 is an interface for displaying events and event notifications generated within the architecture. In other words, monitor 140 acts as the front-end for system 100. Monitor 140 handles notifications regarding the events generated in system 100 (i.e., at agent 110 or server 120), and the actions that occur pursuant to the processing of the event. Monitor 140 also provides a mechanism for customizing event handling. According to one embodiment, monitor 140 may be viewed from a standard web browser. According to another embodiment, an API may be provided to create an application that specifically displays and handles events and notifications to the user.

Agent 110 communicates directly with any event-generating entity within a system in an organization. Examples of the event-generating entities include protocol gateways or interfaces, business applications, databases, or even people. Agent 110 is able to communicate with server 120 via any protocol, such as SOAP.

Agent 110 maintains a communication link so that agent 120 can propagate events up to server 120 to facilitate event notifications to interested parties outside the organization's network. If agent 110 is within an organization, agent 110 can generate notifications to internal systems using common network monitoring protocols such as Simple Network Management Protocol (SNMP), and any messaging protocol, such as Java Message Service (JMS), and/or the like.

Events generated by agent 110 or server 120 may be handled in several ways. For example, information from an event-generating entity (such as a Financial Information Exchange (FIX), Society for Worldwide Interbank Financial Telecommunication (SWIFT) engine, an order management system, and/or the like) may be accessible from the interface of monitor 140, either via a web page, dynamically in a JAVA applet, in a customized implementation of an API and/or the like. According to the configuration and preference information stored in server 120, alerting events can be instantly propagated via e-mail, wireless messaging or paging, telephone, facsimile, web browser, monitor 140 and/or various other methods. Any alerting events that may be of pertinent interest to applications and network management systems may be communicated directly to those systems using appropriate protocols or application interfaces.

As noted above, agent 110 may reside on the local network or computer(s), in which case it may interact with internal and/or external event-generating entities or any application(s) that can interface thereto using an API, such as with a trade order management system.

The agent 110 listens (and/or subscribes) for events (e.g., messages) from event-generating entity 135 and converts these events into well-defined events, having a set type, structure and/or configuration that make the well-defined events usable within system 100. For simplicity, the usable event is referred to as a ttEvent hereinafter.

As context, event-generating entity 135 may be any entity that provides a standard protocol for transactions, such as the FIX Protocol. The FIX Protocol is a message standard developed to facilitate the electronic exchange of information related to securities transactions. The FIX Protocol is intended for use between trading partners wishing to automate communications. The message protocol, as defined, supports a variety of functions. A FIX engine is an object-oriented architecture based on the FIX Protocol with push-based TCP/IP messaging to provide an extremely fast and stable platform for both FIX connectivity and message processing. A more detailed description of the FIX Protocol is provided in the FIX 4.0 Specification, dated Jan. 10, 1997.

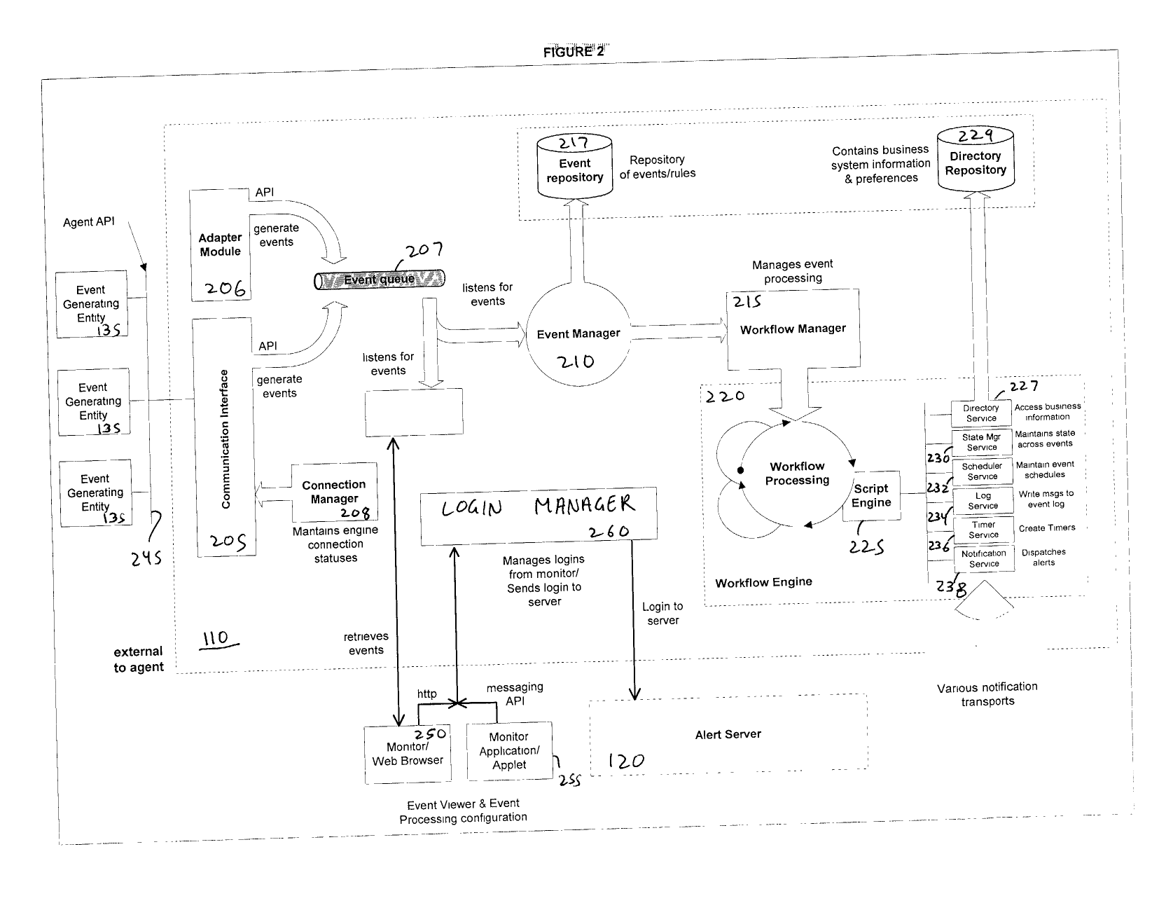

After agent 110 receives a ttEvent, it passes ttEvent to a workflow engine for processing of the event, based upon customizable handling rules (defined in the event handling scripts) that are applicable for such event. The workflow engine processes these ttEvents based on the event handling scripts, and then dispatches a message object to the notification dispatcher (or service) which sends the notification using e-mail, paging, instant messaging, telephone, facsimile, web browser, and/or the like. The workflow engine accesses service objects which are embedded within the context of the workflow engine. The workflow engine performs a variety of other tasks, which will be described in more detail with respect to FIG. 2.

Concurrently with this processing, agent 110 may dispatch the event to server 120 for further processing on the server-side. Server 120 processes this event, and may send the event to yet another agent 110 so that the event may be processed internally at another location.

According to another embodiment, the event may be passed to server 120 but no action is taken with regard to the event, other than storing the event information therein.

It should be noted that agent 110 can also be used to configure the features of an event-generating entity 135, such as a FIX or SWIFT engine, order management system and/or the like that interface with it. For example, agent 110 can communicate with the event-generating entity's API for managing its functionality, such as accessing features of event-generating entity 135, and/or the like. As will be discussed later, agent 110 also acts as an interface to monitor 140.

Server 120 is structured similar to agent 110. Server 120 may also comprise a built-in web server. Server 120 also persists all events and event actions that go through system 100. Furthermore, server 120 can process events like an agent 110 based on a customizable event handling scripts, which have been previously discussed. In particular, server 120 can also act as a message router in that server 120 can forward ttEvents from one agent 110 to another. Thus, the ttEvents can be processed on more than one agent, or on the server if necessary.

Agent 110 and server 120 maintain a communication link with each other for ttEvents and event notification propagation. In one embodiment, server 120 utilizes a simple transfer protocol, such as SOAP, for transporting and encapsulating all messages between agent 110 and server 120 in XML format. The delivery transport for these messages is HTTP. Using prevalent technology for messaging between distributed systems such as SOAP, Corba, and/or the like allows server 120 to be agnostic to the information being passed over HTTP.

Monitor 140 interfaces directly with agent 110. Monitor 140 displays events and handles event notifications, and the actions that occur pursuant to the processing of the ttEvent. Monitor 140 also allows the user to customize event handling by providing an interface to the underlying scripts that define the event handling. Further, monitor 140 may be viewed from a standard web browser. An API may also be provided to create an application that specifically handles the notifications to the user.

The main feature of monitor 140 is to display notifications and provide a mechanism for adding and modifying the customized rules for event handling. Monitor 140 applications may be viewed from a standard web browser, a stand-alone application, and/or and API that provides access to event-generating entities 135. There can be more than one monitor 140 interacting with agent 110.

According to one embodiment, monitor 140 is accessible from a web browser that provides a user with access to information and the ability to interact with system 100. There may also be an application component that can be run independently from the browser. The main screen that is delivered to the operator is a screen that allows the operator to view all events occurring between the event-generating entities and agents 110. In one embodiment, monitor 140 interfaces with the agent's embedded web server for these events.

A user may also be provided an interface for defining generic events and their respective handling using monitor 140. The user may customize these handling mechanisms from the event-handling screens in monitors 140. In one embodiment, the user may also be given an interface for interacting with event-generating entity 135 directly to alter/change its properties. For example, the interface may allow communication with the event-generating entity's API for managing its functionality, such as notifying event-generating entity 135 that it is time to start up based on a scheduling mechanism, accessing features of event-generating entity 135, and/or the like.

An event handler is defined as a script associated with a particular event used in processing. A script is a human readable programmatic source code which is a fully realized program that may contain conditional expressions and logic, a state machine, and access to external services (which provide mechanisms for controlling and managing the processing flow of a an event), which is wholly interpreted by the workflow engine and executed within a processing context. In one embodiment, the event-handling scripts may be authored in any scripting language, such as JAVASCRJPT, PYTHON, PERL, and/or the like, and the scripts are interpreted by an imbedded script-interpreter engine that processes them.

FIG. 2 provides a detailed illustration of one embodiment of a logical framework for agent 110. The agent comprises a framework that possesses an event manager that listens for events, a workflow engine for processing events received within the agent, a workflow manager for controlling priority of events and overseeing the processing of events by the workflow engine, a state manager for maintaining state of the events across the workflow engine, a set of services that are accessible from within the workflow engine and a notification dispatcher for transmitting said events to various delivery means for notifying users with particular information pre-defined by the users. Agent 110 further comprises an API for interfacing with external event-generating entities 135 to receive events addressed to agent 110.

As noted above, agent 110 maintains a communication link so that server 120 can propagate appropriate notifications to interested parties outside the organization's network or to another agent as well as to receive notification information coming in from outside the organization's network or from another agent 110.

Agent 110 comprises an API for event propagation, and is referred to as a communications interface 205 here, for interfacing with external event-generating entity 135, such as a FIX engine. According to one embodiment, for applications that do not interface directly to agent 110, agent 110 also supports an adapter module 206 that generates events by processing log files, databases, process tables, and/or other observable resources. Processing may include parsing, extracting, reading, and/or the like. Communications interface 205 is coupled to an event queue 207. Gateway 205 then translates the event that it receives from other components in system 100 into a ttEvent for agent 110. As noted above, this ttEvent is a typed event, in that each event possesses certain attributes that uniquely define it. The ttEvent may be either pre-defined by the developer of the framework for an agent 110 or the developer for another agent 110 that is capable of interpreting the first agent's events, or be user defined. In other words, alert system 100 allows for users to define their own types of event as well, in accordance with a general framework provided by one embodiment.

The agent also comprises a connection manager 208, which manages all the nodes to be monitored from agent 110. Connection manager 208 further maintains connection statuses for event-generating entities 135 connected to agent 110.

Once an event is generated, communications interface 205 converts it to a ttEvent and places it in event queue 207 for usage by event manager 210. The role of event manager 210 is to handle all the events that come into event queue 207 from communications interface 205. It should be noted that there are two main sources for events: one is the communications interface 205 and the second is the alert server 120. Event manager 210 then processes the ttEvent by placing the ttEvent into a persistent cache 217, which is a local memory cache and may also send the ttEvent up to alert server 120, where it is persistently stored for archival/historical purposes and/or the like. The purpose of storing the ttEvent to a local persistent cache is for recovery purposes if agent 110 crashes or fails. Concurrently, the ttEvent is passed to workflow engine 220 so that the ttEvent can be processed, under the control of workflow manager 215. Workflow manager 215 dispatches events to workflow engine 220 which accesses the services for event processing.

Workflow engine 220 is the heart of agent 110. Workflow engine 220 processes an event handling script that is associated with the generated ttEvent. Each ttEvent has a corresponding event script, which is further described below, thus providing handling for each ttEvent that passes through the system. System 100 also allows the end user to modify the default handling of the rules by providing an interface to the ttEvents and the scripts. Some of the common actions that may occur as a result of the event handling may include, but are not limited to, providing notification to support member(s) regarding event information, logging information to a file, sending a SNMP trap to internal systems, sending notifications to the monitor and/or the like.

Script engine 225 allows scripted processing of events and actions within workflow engine 220. A script is a human readable programmatic source code which is a fully realized program that may contain conditional expressions and logic, a state machine, and access to services, and which is wholly interpreted by the workflow engine and executed within a processing context. Processing may include parsing, extracting, reading, and/or the like. There are various services embedded within script engine 225 that allow the scripts to interact with an external agent or server framework. The services provide mechanisms for controlling and managing the processing flow of a ttEvent. In one embodiment, workflow threads may perform the processing.

One of the services provided is a directory service 227. The directory service 227 interfaces with a directory/repository 229, which stores system information and preferences for underlying agent 110. Directory services 227 may be based on standard industry protocols such as LDAP, UDDI, customized SOAP-based directory services and/or the like.

Another service provided is a state manager service 230. State manager service 230 provides the script the option of embedding state information into a persistent store in order for a ttEvent to check state across many different processing paths. For example, if two ttEvents are being processed from two separate threads, one ttEvent may be dependent on the other to finish processing or to change the state of a particular property.

Another service provided is a scheduling service 232 that provides a means of changing the context under which a script is processed. A context can affect the behavior of the services available to the script.

Script engine 225 also provides a log service 234, which allows the script to write out messages to the action log of an event and/or to a persistent storage device (e.g. database).

Script engine 225 also has a timer service 236, which gives the script the option of creating timers from within the script-processing context. A timer can be used to control the duration of event processing in order for the script to await a particular state change or other subsequent action (i.e., another event of higher priority preempts the current event).

In addition, script engine 225 may have a notification service 238 that gives the script access to the notification dispatcher. This script has access to various mechanisms of notification for particular contact entities that are set up within the system. For example, if a ttEvent occurs that needs to be acknowledged, the script can notify specific parties by accessing the notification service. The script engine may also have various other services because it is extensible and other services can be created and accessed within script-processing engine 225.

A notification dispatcher handles the actions that stem from the processing in workflow engine 220. The notification dispatcher directs the results of the processing of the ttEvents to various transports of delivery to the entities external to system 100. The transports that are available include sending e-mail, paging, instant messaging, directing info to a log file, sending SNMP traps, sending messages out to a messaging bus and/or the like.

Agent 110 is provided with an API 245 for communicating with event-generating entity 135 that sends messages to agent 110 via API 245. API 245 for each of the various publication/subscription messaging protocols (such as CORBA, JAVA RMI, JMS, ActiveX and/or the like) will be created for passing events into agent 110. In other words, API 245 provides an open and flexible mechanism through which vendors of applications, gateways, and messaging hubs can integrate directly with system 100. Through API 245, systems can send alert events through system 100. In addition to providing an event interface, system 100 can also direct event notifications to a counter-party's API or can allow a system to listen to events in agent 110. Applications can take advantage of this functionality by listening for important events from other components in system 100 and responding intelligently, such as disabling trading partners at the user interface when network links are temporarily down, sending automated messages to trading applications to cancel open orders during an extended network outage, and/or the like.

Agent 110 is also provided with a login manager 260 that manages local users to log into agent 110 using monitor 140, such as a browser client 250 or an application applet 255, and subsequently allows agent 110 (and user) to login to alert server 120 via an appropriate protocol. Login manager 260 assigns a unique identifier to agent 110 upon login so those events coming from a particular agent 110 are identifiable and verifiable for security purposes, and authentication for connections to server 120. According to one embodiment, the user may only be allowed to login to server 120 if appropriate permission has been granted prior to the login process.

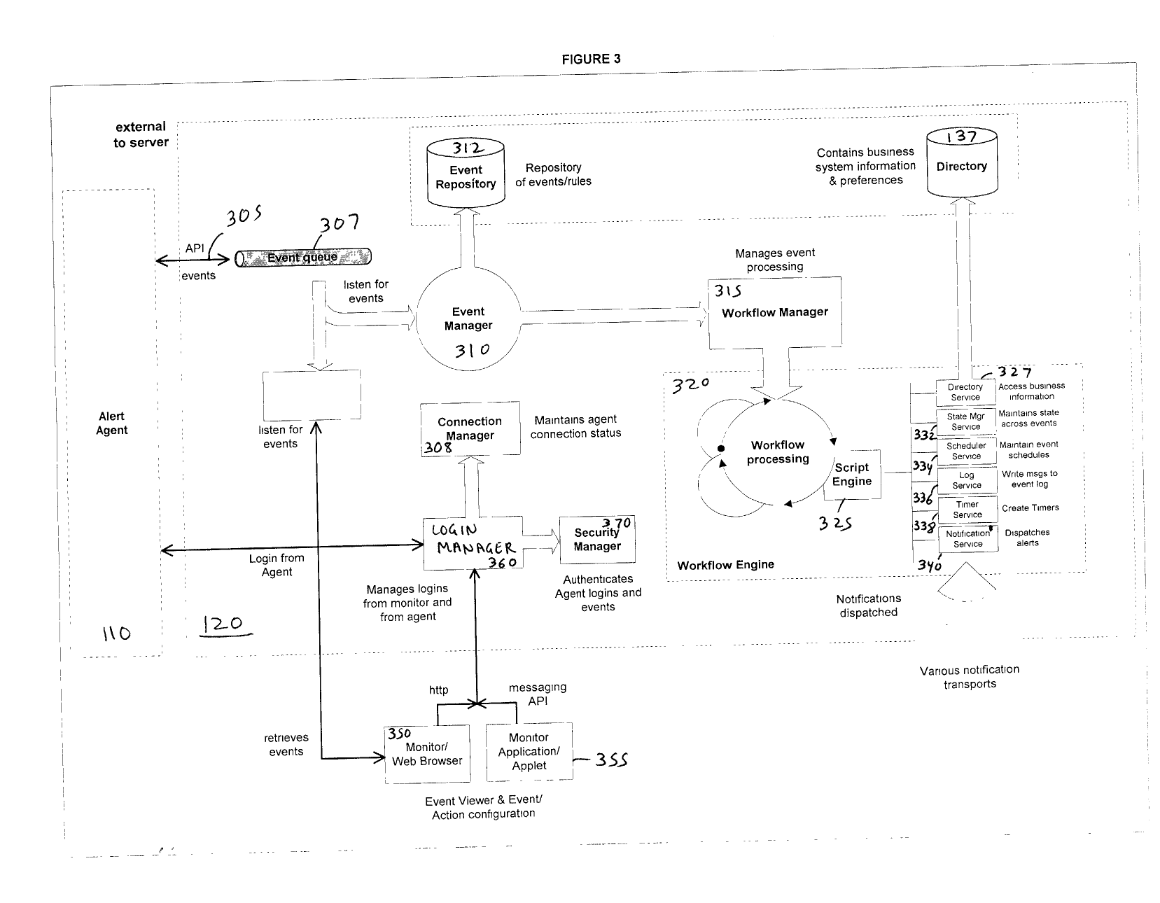

FIG. 3 provides a detailed illustration of server 120. Server 120 comprises a framework that has an event manager for continuously listening for events, a server workflow engine for processing events received within the system, a server workflow manager for controlling priority of events and overseeing the processing of events by the workflow engine, a state manager for maintaining state of the events across the workflow engine, a set of services that are accessible from within the workflow engine, and a notification dispatcher for transmitting said events to various delivery means for notifying users with particular information pre-defined by the users. The server also provides a persistent store for the events flowing in the system, rules used in processing the events by agents as well as the server.

As noted above, server 120 is very similar in its structure to agent 110. Server 120 is coupled to agent 110 over a secure channel, using a protocol such as SOAP and/or the like. The intelligence of system 100 lies within server 120, which has the capability to understand complex monitoring schedules, notification policies, escalation procedures, and/or the like. According to one embodiment, through integration with a repository of directory services 137, server 120 can determine the identities of the persons or entities to notify within a counter-party's organization, in addition to the notification mechanisms. In addition, server 120 also knows the identities and notification mechanisms within the event-generating entities as well as of any networks, messaging providers, or other entities between them.

As noted above, server 120 persists all events that come through the system 100 to a flat-file and/or to a database 312 (using standard JDBC drivers). The persistence of these messages may be used for historical event viewing, event synchronization, historical audits, computing event statistics, and/or the like.

Agent 110 provides events to server 120 using an appropriate delivery transport, such as the SOAP protocol. To receive the events, server 120 comprises an API 305 that listens for events. API 305 listens to various publication/subscription messaging protocols and allows interaction with agents 110.

Once in server 120, the ttEvent is placed in event queue 307 for usage by event manager 310. Event manager 310 listens for ttEvents. If a ttEvent is available in queue 307, event manager 310 receives it. Event manager 310 then processes the ttEvent by placing the ttEvent into persistent cache 312, such as a database, for archival/historical purposes and/or the like. Concurrently, the ttEvent also is passed through to workflow engine 320 so that the ttEvent can be processed, under the control of workflow manager 315. Workflow manager 315 dispatches ttEvents to workflow engine 320 which accesses the services for event processing.

Workflow engine 320 is the heart of server 120. Workflow engine 320 processes an event handling script that is associated with the generated event. Each ttEvent has a corresponding event script, thus providing handling for each ttEvent that passes through the system. System 100 also allows the end user to modify the default handling of the rules by providing an interface to the ttEvents and the scripts. Some of the common actions that may occur as a result of the event handling may include, but are not limited to, providing notification to support member(s) regarding event information, logging information to a file, sending a SNMP trap to internal systems, sending notifications to the monitor, and/or the like.

A script engine 325 allows scripted processing of events and actions within workflow engine 320. Similar to agent 110, there are various services embedded within script engine 325 that allow the scripts to interact with an agent or server framework. The services provide mechanisms for controlling and managing the processing flow of a ttEvent.

One of the services provided is a directory service 327. As noted above, directory services 137 facilitate querying and publishing to a repository or repositories of information to assist different networks 130 in establishing connectivity directly with each other. Directory services 137 are based on standard industry protocols such as LDAP, UDDI, customized SOAP-based directory services and/or the like. Directory services 137 may also provide information that assists with discovery of potential counter-parties, products and markets in which they trade or do business, the protocol and/or system interfaces they support, and any other information necessary for defining, handling and/or processing events in system 100.

Another service provided is a state manager service 332. The state manager service 332 gives the script the option of embedding state information into a persistent store in order for a ttEvent to check state across many different processing paths. For example, if two ttEvents are being processed from two separate threads 322, one ttEvent may be dependent on the other to finish processing or to change the state of a particular property.

Another service provided is a scheduling service 334 that provides a means of changing the context under which a script is processed. A context can affect the behavior of the services available to the script.

Script engine 325 also provides a log service 336 which allows the script to write out messages to the action log of an event and/or to a persistent storage device (e.g. a database).

Script engine 325 also has a timer service 338, which gives the script the option of creating timers from within the script-processing context. A timer can be used to control the duration of event processing in order for the script to await a particular state change or other subsequent action (i.e., another event of higher priority preempts the current event).

In addition, script engine 325 may have a notification service 340 that gives the script access to the notification dispatcher. This script has access to various mechanisms of notification for particular contact entities that are set up within the system. For example, if an event occurs that needs to be acknowledged, the script can notify specific parties by accessing the notification service. The script engine may also have various other services because it is extensible and other services can be created and accessed within script-processing engine 325.

A notification dispatcher handles the actions that stem from the processing in workflow engine 320. The notification dispatcher directs the results of the processing of the ttEvents to various transports of delivery to the entities external to system 100. The transports that are available include sending e-mail, paging, instant messaging, directing info to a log file, sending SNMP traps, sending messages out to a messaging bus and/or the like.

Further, rules for handling ttEvents are cached on the server side and sent down to an agent process once agent 10 logs onto network 100. Rules and rule handling may also be cached on agent 110, so that various features of agent 110 still work when communication between agent 110 and server 120 is severed. This cache may be an in-memory cache, a flat-file, or any other suitable storage means. Workflow engine 320 processes a ttEvent based on specific rules that apply to particular events, or uses a generic event handler for processing. Each ttEvent has a corresponding event script, thus providing handling for each event that passes through system 100. Some common actions that may occur out of the event processing may include notifying support member(s) of event information, logging of information to a file, sending a SNMP trap to internal systems and/or the like. A notification dispatcher 340 handles the actions that stem from the processing in workflow engine 320.

Notification dispatcher 340 may propagate the events via various delivery transports to interested parties, based on user-defined rules or directory services information. Delivery transports may include e-mail, paging, instant messaging, telephone, facsimile, directing info to a log file, sending SNMP traps, sending messages out to a messaging bus and/or the like.

Server 120 also comprises a login manager 360. Login manager 360 enables logins into server 120 from agents 110 and also allows users to login using monitors 140, such as browser clients 350 and application applets 355. Login manager 360 assigns a unique identifier upon login to identify the users and agents 110 logging in. Using the assigned identifiers, login manager 360 captures and maintains the identities of entities/users who are allowed access to system 100 from an agent 110 and validates the logins from the various agents 110.

Login manager 360 is coupled to a security manager 370. Security manager 370 ensures that all information that is passed to server 120 is reliable. Login manager 360 originally assigns a unique identifier that must be present in each message that arrives from agent 110. If a false message is sent to server 120 (i.e., the message fails the authentication), the message is flagged as an invalid event and is handled accordingly by workflow engine 320 of server 120.

There is also a connection manager 308 that keeps track of previous states of connections and, based on a combination of such information and a current connection-related event, generates a ttEvent.

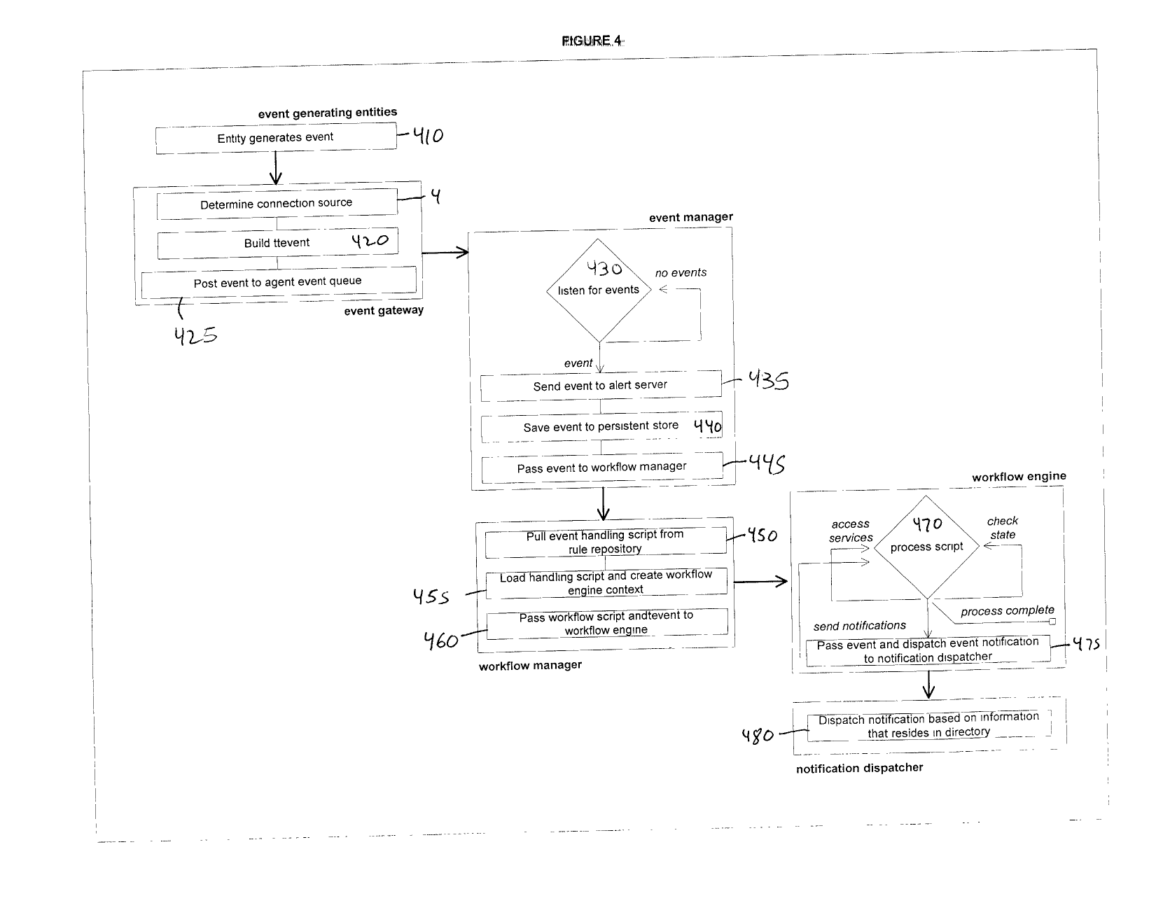

FIG. 4 shows the flow within the agent 110 in accordance with one embodiment. Initially, in the event-generating entity 135, such as the FIX engine, an event is generated in Step 410. The event-generating entity 135 acts as a gateway between a client and network, which may be a Local Area Network, Wide Area Network, the Internet, and/or the like.

Next, the event is passed from the event-generating entity to the communications interface 205. Within the communications interface 205, in Step 415, the source of the occurring event is determined from both the attributes of the event and the connection manager 208. Next, in Step 420, the received event is converted into a ttEvent. As noted above, the ttEvent is the internal configuration for the event. In step 425, the ttEvent is posted to the agent event queue 207, and the control (i.e., the logic flow) moves to the event manager 210.

At step 430, the event manager 210 listens for ttEvents. In other words, the event manager 210 checks to see if any event is present. If there are no events available, then the control/flow remains at step 430 and the program flow blocks further events until the presence of new and incoming events at the event-generating entity 135 is detected. Concurrently, non-event related actions may be performed within the agent 110 and/or the system 100, such as system maintenance. On the other hand, if an event is detected then the event manager 210 sends the ttEvent to the server 120 in step 435. In step 440, the ttEvent is saved to a storage device for recovery in the event that the agent 110 crashes or otherwise fails. In step 445, the ttEvent is passed to the workflow manager 215.

Once the event is in the workflow manager 215, an event handling script is retrieved from a local repository of scripts, or if the agent 110 does not have the necessary scripts, the agent 110 signals the server 120 to provide the updated scripts, in step 450. The event handling script may be unique for each customer or user utilizing the present monitoring system, or it may be provided in one standard design. In step 455, a workflow process is created and a handling script is loaded into the system. The handling script is processed by the script engine 225, as mentioned above. Next, in step 460 the workflow object and the ttEvent are passed to the script engine 225.

Once the ttEvent is in the script engine 225, the script engine 225 interprets the script code that is stored therein to process the received ttEvent for checking its state. The processing can continue through a chain of event handlers for complete processing. In step 470, during the processing, the notification service 238 can be accessed to dispatch notifications to the notification dispatcher.

At the notification dispatcher, in step 475, the event is dispatched (i.e., transmitted internally or externally) based upon pre-determined criteria that may be configured using the monitors 140. For example, in one embodiment, the policy may be determined by pre-selected rules chosen by the users of the system 100 and/or the organizations where the system 100 is implemented or supported. The notifications may be sent to customers of the organizations, users, maintenance personnel, network administrators and/or the like using e-mail, paging devices, instant messaging, or any other similar notification tools, in step 480. According to one embodiment, the recipient of the notification may be required to acknowledge the notification, or a new notification may be sent via a different dispatch vehicle or to a different entity.

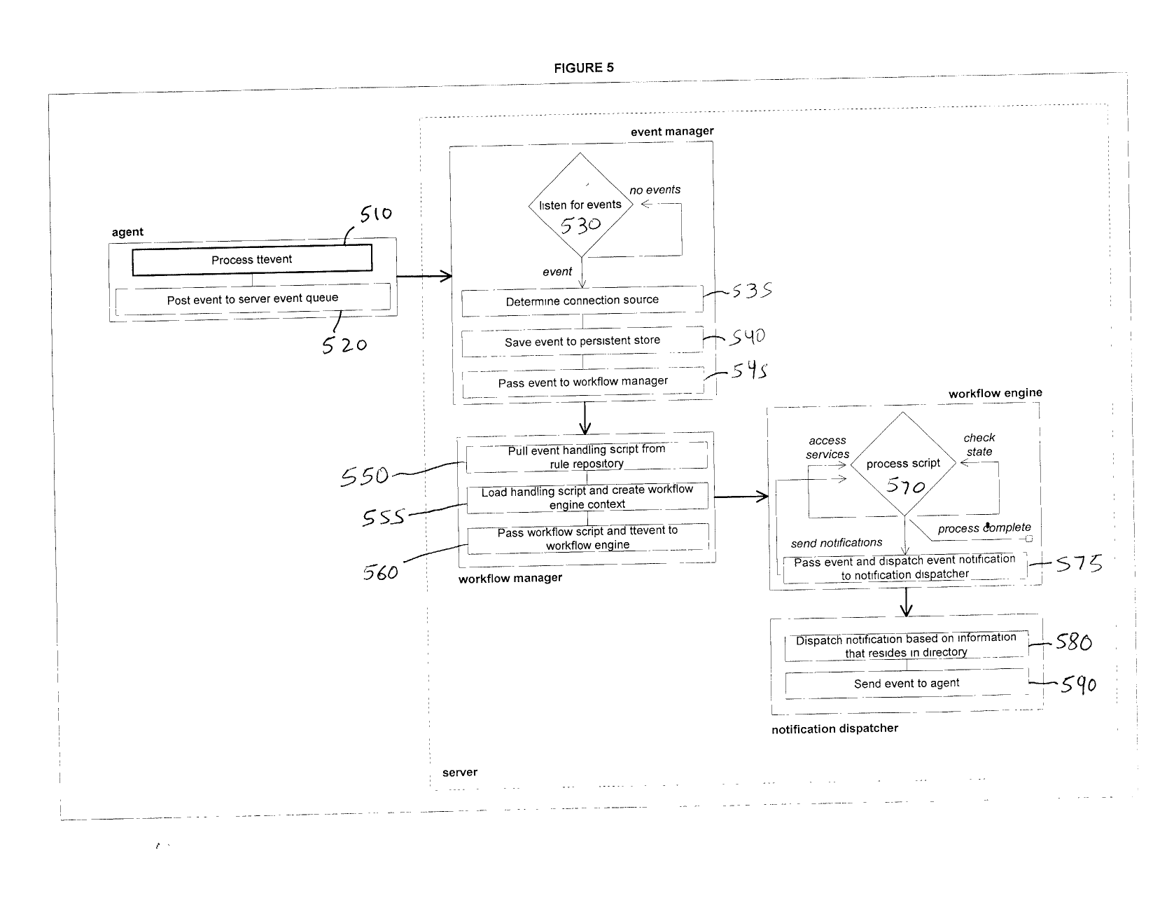

FIG. 5 illustrates the flow within the server 120. Initially, the ttEvent is processed in the agent 110, as shown in box 510. After processing the ttEvent, the agent 110 posts the ttEvent to a server event queue 307 via an appropriate protocol, such as the SOAP protocol, in step 520.

Once the ttEvent has been posted to the server event queue 307, the server 120 takes over the management and/or processing of the ttEvents. Accordingly, the ttEvent is initially passed to the event manager 310. In step 530, the event manager 310 listens for ttEvent. In other words, the event manager 310 checks to see if any ttEvent is present in the server 120. If no ttEvents are present, the event manager 310 continues to periodically listen for any new ttEvents that may enter the server event queue 307. On the other hand, if a ttEvent is already present in the server event queue 307, the control (i.e., logic flow) moves to step 535, where the connection source is determined.

In step 540, the ttEvent is saved to a storage device as noted above for the purpose of archiving the ttEvents. Next, in step 545, the ttEvent is passed to a workflow manager 315.

Once the control has passed to the workflow manager 315, in step 550, the workflow manager 315 pulls/retrieves an event handling script from an associated database. As noted above, the event handling script maybe unique for each individual agent 110 using the system 100, or it may be prepackaged, such as where the same event handling script is to be used by each subscriber of the system 100. In step 555, a workflow process is initiated along with loading of the handling script for manage/handling the created workflow thread. In one embodiment, the workflow process may be initiated by creating workflow threads. In step 560, the workflow object and ttEvent are passed to the script engine 325.

Once the ttEvent has been passed to the script engine 330, in step 570, and the script code is interpreted to check the state of the ttEvent being passed to the script engine 330. The processing can continue through a chain of event handlers for complete processing. In step 575, during the processing, the notification service 240 can be accessed to dispatch notifications to the notification dispatcher.

At the notification dispatcher 240, in step 580, the event is dispatched (i.e., transmitted internally or externally) based upon pre-determined criteria that may be configured using the monitors 140. For example, in one embodiment, the policy may be determined by pre-selected rules chosen by the users of the system 100 and/or the organizations where the system 100 is implemented or supported. The notifications may be sent to customers of the organizations, users, maintenance personnel, network administrators and/or the like using e-mail, paging devices, instant messaging, or any other similar notification tools, in step 585. Finally, in step 590, the notification is sent to the agent 110.

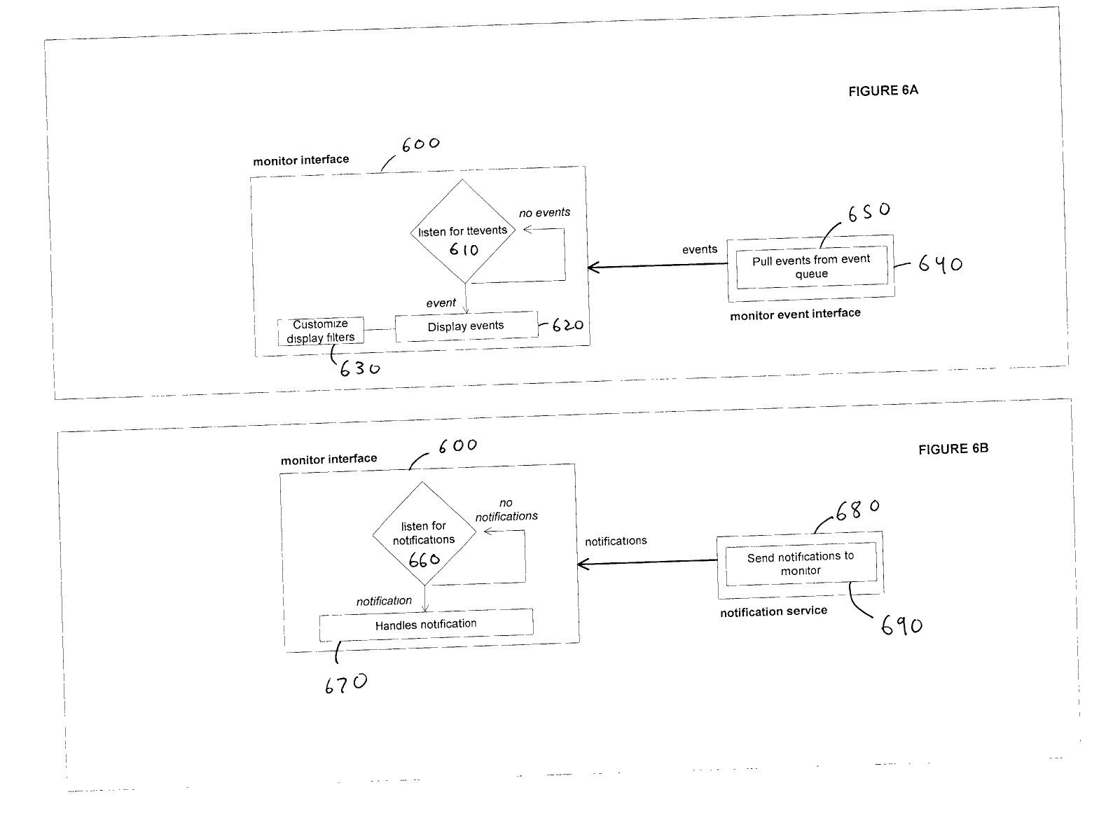

FIG. 6A provides an illustration of the flow in the monitor 140 for displaying events that occur at the agent. The monitor listens for events by interfacing with a monitor event interface 600 in the agent. The user can change the events that are being displayed, by interacting with display filters.

The monitor comprises a web browser or an applet 600 that utilizes the monitor API 640, as shown in FIG. 6. In step 610, the web browser or the applet 600 listens for ttEvents (i.e., listens for events in the queue 207). If no ttEvents are present, the web browser or the applet continues listening for any new/incoming ttEvents on a periodic basis. In accordance with one embodiment, the listening frequency may be determined by the subscribers and/or the entities managing the servers 120. If an event is present, then the ttEvent and the event action are displayed in step 620. The display may take place with the users, the customers and/or the managers at the agent 110 as well as at the server 120. In step 630, the users are allowed to customize the display filters to ensure that the ttEvents and the event actions are displayed in a desired format.

In step 650, the flow proceeds to the monitor event interface 640, where events are pulled/retrieved from the event queue 207 to decide the actions that need to be performed in response to the processing of the ttEvents. In one embodiment, a list of possible actions can be displayed as well. As has already been described above, once the ttEvents are pulled from the event queue, a number of actions may take place, such as providing notification to the users via e-mails, paging devices, instant messaging, displaying the actions taken as attributes of the event, and/or the like.

FIG. 6B provides an illustration of a flow in the monitor 140 to handle notifications. In one embodiment, the agent has the ability to direct notifications to a monitor by popping up message windows and dialup boxes. The agent may send a notification to the monitor through a notification dispatcher, wherein the monitor would be listening for notifications.

Using the monitor interface 600, the web browser or the applet 600 listens for notifications. If no notifications exist, the monitor continues listening for any new/incoming notifications on a periodic basis. In accordance with one embodiment, the listening frequency may be determined by the subscribers and/or the entities managing the servers 120. If an event is present, then the notifications are appropriately handled in step 670.

In step 690, the flow proceeds to the notification service 680 from where notifications are sent to the monitor 140. As noted above, the monitor may provide notifications in step 670 to users via e-mails, paging devices, instant messaging, displaying the actions taken as attributes of the event, and/or the like.

In addition to monitoring or status notification, the method, system and apparatus for establishing, monitoring and managing connectivity for communication among heterogeneous systems provides an immediate, real-time platform for accessing and updating directory information. The server's basic understanding of schedules and notification rules may be extended by any application or platform to include more system-specific information, such as discrete configuration parameters for the network, which presents useful opportunities for using the architecture 100 to implement powerful capabilities such as remote configuration management or monitoring.

Thus, in summary, herein is disclosed a method, system and apparatus for establishing, monitoring and managing connectivity for communication among heterogeneous systems. The system for automatically establishing, monitoring and managing connectivity for communication among heterogeneous systems comprises a server for processing incoming events, an agent resident on one of the disparate networks, and a monitor coupled to the agent, where the monitor displays notifications and enables event handling. The agent remains in communication with the server to facilitate monitoring and error handling by one or more system connected to the server. The server acts as a message router for forwarding events between one or more agents, and the server further stores events and event actions that flow through the system.

As described above, the agent 110 is capable of performing a plurality of functions to provide monitoring information, including generating notifications to the server 120 as well as internally using various different protocols, retrieving and caching notification templates and policies from the server 120, and communicating updates when necessary; communicating directly with any relevant applications and processes though an open API; and indirectly monitoring processes and applications through a scriptable interface that is capable of observing log files and/or the like.

Further, server 120 performs a number of functions, including maintaining and communicating notification policies and schedules; implementing default event handlers for general-purpose notifications; defining custom events; and providing scriptable handlers to flexibly support user-defined responses to handle custom events or override default behaviors.

Monitor 140 defines and updates schedules and policies remotely, monitors events and notifications from anywhere, and secures web client interface as well as optional dynamic applet client.

Although illustrative embodiments have been described herein in detail, it should be noted and understood that the descriptions have been provided for purposes of illustration only and that other variations both in form and detail can be made thereupon without departing from the spirit and scope of this invention. The terms and expressions have been used as terms of description and not terms of limitation. There is no limitation to use the terms or expressions to exclude any equivalents of features shown and described or portions thereof and this invention shown be defined with the claims that follow.

What is claimed is:

1. A method for event communication among networks having a plurality of systems, comprising:
receiving an event signal in a client, said event signal transmitted by an event-generating entity coupled thereto;
obtaining a pre-determined rule associated with said event; and
processing said event in accordance with said pre-determined rule.

2. The method of claim 1, further comprising transmitting said event to a server before said obtaining.

3. The method of claim 1, wherein said event is assigned a priority level in accordance with a pre-determined criterion.

4. The method of claim 3, wherein said processing is performed in accordance with said assigned priority level.

5. The method of claim 1, further comprising converting said event into a well-defined event.

6. The method of claim 5, wherein said event is divided into a plurality of workflow threads that are processed simultaneously.

7. The method of claim 1, further comprising receiving user instructions to configure said pre-determined rule.

8. The method of claim 7, wherein said user instructions are received from a web browser.

9. The method of claim 7, wherein said user instructions are received from a customized application.

10. The method of claim 9, wherein said customized application handles and displays said notifications.

11. The method of claim 7, further comprising accessing a directory service for accessing information and operational preferences for said client.

12. The method of claim 11, further comprising embedding state information into a persistent store on said client for said event.

13. The method of claim 12, further comprising providing a notification service, said notification service allowing access to a notification dispatcher for said transmitting of said notifications.

14. The method of claim 13, wherein said notification dispatcher provides access to at least one mechanism of notification, said notification provided as a result of said processing.

15. The method of claim 14, wherein said mechanism of notification is one of an electronic mail, paging, web browsing and instant messaging.

16. The method of claim 12, wherein said rule is provided as an executable script, said executable script actuating said processing of said well-defined event.

17. The method of claim 12, further comprising creating timers to control the duration of processing of said well-defined events.

18. The method of claim 1, further comprising accessing a directory service for accessing information and operational preferences for said client.

19. The method of claim 1, further comprising embedding state information into a persistent store on said client for said event.

20. The method of claim 1, further comprising providing a notification service, said notification service allowing access to a notification dispatcher for said transmitting of said notifications.

21. The method of claim 20, wherein said notification dispatcher provides access to at least one mechanism of notification, said notification provided as a result of said processing.

22. The method of claim 1, further comprising creating timers to control the duration of processing of said well-defined events.

23. The method of claim 1, wherein said rule is provided as an executable script, said executable script actuating said processing of said well-defined event.

24. The method of claim 2, further comprising transmitting notifications as a result of the processing.

25. The method of claim 2, further comprising:
receiving said event in said server from said client coupled thereto;
obtaining a predetermined rule associated with said event; and
processing said event in accordance with said predetermined rule.

26. The method of claim 25, further comprising transmitting notifications as a result of the processing.

27. The method of claim 25, wherein said rule is provided as an executable script.

28. The method of claim 27, wherein said executable script is stored in a repository associated with said server.

29. The method of claim 28, wherein said server is a distributed server.

30. The method of claim 29, further comprising synchronizing the result of processing said well-defined event within said server.

31. The method of claim 28, further comprising creating a workflow thread for said event.

32. The method of claim 31, wherein said workflow thread is acted upon during said processing in accordance with said executable script associated therewith.

33. The method of claim 27, wherein said executable script is configured to provide customized service during said processing.

34. The method of claim 33, wherein said customized service provides access to a repository that facilitates querying and publishing of information.

35. The method of claim 34, wherein said information assists said systems in managing connectivity therebetween.

36. The method of claim 33, wherein said customized service causes said executable script to embed state information into a persistent storage means for allowing said event to check state across more than one processing paths.

37. The method of claim 36, wherein said customized service further gives said executable script access to schedules to determine flow of processing of said event.

38. The method of claim 37, wherein said customized service further allows said executable script to write messages to an action log of the event and to a storage device.

39. The method of claim 38, wherein said customized service further allows said executable script to create timers to control duration of processing of said events.

40. The method of claim 39, wherein said customized service further allows said executable script access to a notification dispatcher, said notification dispatcher transmitting said notifications.

41. The method of claim 40, further comprising receiving acknowledgement of said dispatched notification.

42. The method of claim 37, wherein said scheduling is controlled by processing an event in a counter party agent.

43. The method of claim 33, wherein said customized service gives said executable script access to schedules to determine flow of processing of said well-defined events.

44. The method of claim 33, wherein said customized service allows said executable script to write messages to an action log of the well-defined event and to a storage device.

45. The method of claim 33, wherein said customized service allows said executable scripts to create timers to control duration of processing of said well-defined events.

46. The method of claim 33, wherein said customized service allows said executable scripts access to a notification dispatcher, said notification dispatcher transmitting said notifications.

47. The method of claim 46, further comprising receiving acknowledgement of said dispatched notification.

48. The method of claim 25, further comprising assigning a priority level to said well-defined event in accordance with a pre-determined criterion.

49. The method of claim 48, further comprising scheduling said well-defined event in accordance with said priority level.

50. The method of claim 49, wherein said processing is performed in accordance with said priority level.

51. The method of claim 1, further comprising assigning a priority level to said well-defined event in accordance with a pre-determined criterion.

52. The method of claim 51, further comprising scheduling said well-defined event in accordance with said priority level.

53. The method of claim 52, wherein said processing is performed in accordance with said priority level.

54. The method of claim 1, wherein an executable script is configured to provide customized service during said processing.

55. The method of claim 54, further comprising creating a workflow thread for said well-defined event.

56. The method of claim 55, wherein said workflow thread is acted upon during said processing in accordance with said executable script associated therewith.

57. The method of claim 1, wherein said rule is provided as an executable script.

58. The method of claim 57, wherein said customized service further allows said executable script access to a notification dispatcher, said notification dispatcher transmitting said notifications.

59. The method of claim 58, wherein said customized service causes said executable script to embed state information into a persistent storage means for allowing said event to check state across more than one processing paths.

60. The method of claim 59, wherein said customized service further gives said executable script access to schedules to determine flow of processing of said events.

61. The method of claim 60, wherein said customized service further allows said executable script to write messages to an action log of the event and to a storage device.

62. The method of claim 61, wherein said customized service further allows said executable script to create timers to control duration of processing of said events.

63. The method of claim 57, further comprising receiving acknowledgement of said dispatched notification.

64. The method of claim 57, wherein said notification is provided by one of an electronic mail, paging, web browsing and instant messaging.

65. A method for event communication among networks having a plurality of systems, comprising:
receiving an event at a server, wherein the event is forwarded to said server from a client coupled thereto;
obtaining event handling scripts from a storage device associated with the server; and
creating a workflow process for processing said event.

66. The method of claim 65, further comprising dispatching a notification based upon the processing of said event.

67. The method of claim 66, further comprising accessing a repository for querying and publishing information between at least two of said plurality of systems.

68. The method of claim 67, wherein said repository provides information for one of defining, handling and processing events in said systems.

69. The method of claim 68, wherein said repository provides information to assist in discovery of information on a potential counter-party.

70. The method of claim 67, further comprising listening for determining presence of events at the server.

71. The method of claim 70, wherein said server is a distributed server, the method further comprising synchronizing a result of processing said event received in said distributed server.

72. The method of claim 71, further comprising loading a handling script for processing the subsection of said event.

73. The method of claim 72, further comprising saving said event received at the server in said storage device, said storage device associated with the server.

74. The method of claim 72, further comprising dispatching said processed events by one of electronic mail, paging devices, web browsers and instant messaging.

75. The method of claim 74, further comprising dispatching notification of said processed event to the client.

76. The method of claim 72, wherein said event is processed in a workflow thread.

77. The method of claim 72, wherein storage device is a database.

78. A method for event communication among networks having a plurality of systems, comprising:
receiving an event at one of said plurality of networks;
retrieving an event handling script for processing said typed event; and
processing said event within said script engine in accordance with a predetermined handling script associated with said event.

79. The method of claim 78, further comprising sending a notification of said event to a server coupled to said client, said notification providing monitoring information for said one of said plurality of networks.

80. The method of claim 79, further comprising dispatching a notification in conformance with a predetermined dispatch policy.

81. The method of claim 80, further comprising converting said event into a well-defined event, wherein said well-defined event facilitates processing of said event in said one of said plurality of networks.

82. The method of claim 78, further comprising checking an event queue for availability of well-defined events, after said receiving.

83. The method of claim 82, further comprising saving said well-defined event to a repository.

84. The method of claim 80, wherein said notification is dispatched by one of electronic mail, paging devices, web browser and instant messaging.

85. A method for event communication among networks having a plurality of systems, comprising:
receiving an event at a first network in said plurality of networks;
processing said event at said first network in accordance with a predetermined handling script associated with said event; and
dispatching a notification in conformance with a predetermined dispatch policy.

86. The method of claim 85, further comprising sending a notification of said event to a server coupled to said client.

87. The method of claim 86, wherein said notification provides monitoring information regarding said first network.

88. A method for event communication among networks having a plurality of systems, comprising:
receiving an event at a first network in said plurality of networks;
transmitting said event to a second network in said plurality of networks;
processing said event at said second network in accordance with a predetermined handling script associated with said event; and
dispatching a notification in conformance with a predetermined dispatch policy.

89. The method of claim 88, wherein said handling script is received from said first network, said handling script customized for processing said event.

90. The method of claim 88, wherein said handling script is received from said second network, said handling script customized for processing said event.

91. A system for event communication among networks having a plurality of systems, comprising:
a server;
an agent resident on one of said plurality of networks, wherein said agent communicates with said server; and
a monitor coupled to said agent, wherein said monitor handles and displays notifications and enables event handling in said agent,
wherein said server further acts as a message router for forwarding events between one or more agents, said agent providing said server with connectivity information, said server further persisting events and event actions that flow through the system.

92. The system of claim 91, wherein said server further comprises:
a server event manager for continuously discovering an event entering said server;
a server workflow engine for processing said event received within the server;
a server workflow manager for controlling and overseeing the processing of said event by the workflow engine;
a server state manager for maintaining state of said event across said server; and
a notification dispatcher for transmitting information of said event through delivery means to one of a user and automated message receiver.

93. The system of claim 92, wherein said server workflow engine comprises:
at least one server workflow thread for allowing division of the workflow into a smaller task, wherein said task can be performed independently; and
a script engine for providing scripted processing of events and actions within said server workflow engine.

94. The system of claim 92, wherein said server further comprises an application program interface for communicating with various messaging protocols.

95. The system of claim 94, wherein said application program interface further allows interaction with client systems.

96. The system of claim 92, wherein said server further comprises a security manager for ensuring that information passed to the server is reliable.

97. The system of claim 96, wherein said server comprises a storage device for saving said event.

98. The system of claim 97, wherein said server comprises a repository for storing information to define, handle and process said event.

99. The system of claim 92, wherein said agent comprises:
an agent event manager for detecting an event entering said agent;
an agent workflow engine for processing event received within said agent;
an agent workflow manager for controlling and overseeing the processing of events by the workflow engine;
an agent state manager for maintaining state of the server across one or more events in the system; and
an agent notification dispatcher for transmitting said events to various delivery means for notifying users of the system.

100. The system of claim 99, wherein said agent further comprises an event application program interface for interfacing with external engines to receive events addressed to said agent.

101. The system of claim 100, wherein said agent further comprises a connection manager for managing connections to said agent.

102. The system of claim 99, wherein said agent workflow engine comprises:
at least one agent workflow thread for allowing division of the workflow into a smaller task, wherein said task can be performed independently; and
a script engine for providing scripted processing of events and actions within said agent workflow engine.

103. The system of claim 102, wherein said agent further comprises an application program interface for communicating with various messaging protocols.

104. The system of claim 103, wherein said application program interface further allows interaction with client systems.

105. The system of claim 99, wherein said monitor provides displays of notifications regarding said events.

106. The system of claim 91, wherein said agent comprises:
an agent event manager for continuously listening for events on a periodic basis;
an agent workflow engine for processing event received within the system;
an agent workflow manager for controlling and overseeing the processing of events by the workflow engine;
an agent state manager for maintaining state of the server across one or more events in the system; and
an agent notification dispatcher for transmitting said events to various delivery means for notifying users of the system.

107. The system of claim 106, wherein said agent further comprises an event application program interface for interfacing with external engines to receive events addressed to said agent.

108. The system of claim 107, wherein said agent further comprises a connection manager for managing connection to said agent.

109. The system of claim 108, wherein said agent workflow engine comprises:
at least one agent workflow thread for allowing division of the workflow into a smaller task, wherein said task can be performed independently; and
a script engine for providing scripted processing of events and actions within said agent workflow engine.

110. The system of claim 108, wherein said agent further comprises an application program interface for communicating with various messaging protocols.

111. The system of claim 110, wherein said application program interface further allows interaction with client systems.

112. The system of claim 91, wherein said monitor provides handles and displays notifications regarding said events.

113. The system of claim 112, wherein said monitor allows modification of customized rules for event handling.

114. The system of claim 113, wherein said monitor may be viewed from a standard web browser.

115. The system of claim 114, wherein said monitor may be viewed from a customized application.

116. A system for event communication among networks having a plurality of systems, comprising:
means for receiving an event signal in a client, said event signal transmitted by an event-generating entity coupled thereto;
means for obtaining a pre-determined rule associated with said event; and
means for processing said event in accordance with said predetermined rule.

117. The system of claim 116, further comprising means for transmitting said event to a server before said obtaining.

118. The system of claim 116, further comprising means for converting said event into a well-defined event.

119. The system of claim 116, further comprising means for receiving user instructions to configure said pre-determined rule.

120. The system of claim 119, further comprising means for accessing a directory service for accessing information and operational preferences for said client.

121. The system of claim 120, further comprising means for embedding state information into a persistent store on said client for said event.

122. The system of claim 121, further comprising means for providing a notification service, said notification service allowing access to a notification dispatcher for said transmitting of said notifications.

123. The system of claim 122, further comprising means for creating timers to control the duration of processing of said well-defined events.

124. The system of claim 116, further comprising means for accessing a directory service for accessing information and operational preferences for said client.

125. The system of claim 116, further comprising means for embedding state information into a persistent store on said client for said event.

126. The system of claim 116, further comprising means for providing a notification service, said notification service allowing access to a notification dispatcher for said transmitting of said notifications.

127. The system of claim 116, further comprising means for creating timers to control the duration of processing of said well-defined events.

128. The system of claim 116, further comprising means for transmitting notifications as a result of the processing.

129. The system of claim 117, further comprising:
means for receiving said event in said server from said client coupled thereto;
means for obtaining a pre-determined rule associated with said event; and
means for processing said event in accordance with said pre-determined rule.

130. The system of claim 129, further comprising means for transmitting notifications as a result of the processing.

131. The system of claim 130, further comprising an executable script configured to provide customized service during said processing.

132. The system of claim 131, wherein said customized service provides access to a repository that facilitates querying and publishing of information.

133. The system of claim 132, wherein said information assists said systems in establishing connectivity therebetween.

134. The system of claim 131, wherein said customized service causes said executable script to embed state information into a persistent storage means for allowing said event to check state across more than one processing paths.

135. The system of claim 131, wherein said customized service further gives said executable script access to schedules to determine flow of processing of said event.

136. The system of claim 131, wherein said customized service further allows said executable script access to a notification dispatcher, said notification dispatcher transmitting said notifications.

137. The system of claim 136, further comprising means for receiving acknowledgement of said dispatched notification.

138. The system of claim 131, further comprising means for assigning a priority level to said event in accordance with a pre-determined criterion.

139. The system of claim 138, further comprising means for scheduling said event in accordance with said priority level.

140. The system of claim 116, further comprising means for assigning a priority level to said event in accordance with a pre-determined criterion.

141. The system of claim 140, further comprising means for scheduling said well-defined event in accordance with said priority level.

142. A system for event communication among networks having a plurality of systems, comprising:
means for receiving an event at a server, wherein the event is forwarded to said server from a client coupled thereto;
means for obtaining event handling scripts from a storage device associated with the server; and
means for creating a workflow process for processing said event.

143. The system of claim 142, further comprising means for dispatching a notification based upon the processing of said event.

144. The system of claim 142, further comprising means for accessing a repository for querying and publishing information between at least two of said plurality of systems.

145. The system of claim 142, further comprising means for listening for determining presence of events at the server.

146. The system of claim 145, further comprising means for loading a handling script for processing a subsection of said event.

147. The system of claim 146, further comprising means for dispatching a notification for said processed events by one of electronic mail, paging devices, web browsers and instant messaging.

148. A system for event communication among networks having a plurality of systems, comprising:
means for receiving an event at one of said plurality of networks;
means for retrieving an event handling script for processing said typed event; and
means for processing said event within said script engine in accordance with a predetermined handling script associated with said event.

149. The system of claim 148, further comprising means for sending a notification of said event to a server coupled to said client, said notification providing monitoring information for said one of said plurality of networks.

150. The system of claim 149, further comprising means for dispatching a notification in conformance with a predetermined dispatch policy.

151. The system of claim 150, further comprising means for converting said event into a well-defined event, wherein said well-defined event facilitates processing of said event in said one of said plurality of networks.

152. The system of claim 150, further comprising means for saving said well-defined event to a repository.

153. A system for event communication among networks having a plurality of systems, comprising:
means for receiving an event at a first network in said plurality of networks;
means for processing said event at said first network in accordance with a predetermined handling script associated with said event; and
means for dispatching a notification in conformance with a predetermined dispatch policy.

154. The system of claim 153, further comprising means for sending a notification of said event to a server coupled to said client.

155. A system for event communication among networks having a plurality of systems, comprising:
means for receiving an event at a first network in said plurality of networks;
means for transmitting said event to a second network in said plurality of networks;
means for processing said event at said second network in accordance with a predetermined handling script associated with said event; and
means for dispatching a notification in conformance with a predetermined dispatch policy.

156. A system for event communication among networks having a plurality of systems, comprising:
a. a memory;
b. a processing unit disposed in communication with said memory unit, wherein said processing unit is configured for:
receiving an event signal in a client, said event signal transmitted by an event-generating entity coupled thereto;
obtaining a pre-determined rule associated with said event; and
processing said event in accordance with said pre-determined rule.

157. The system of claim 156, wherein said processing unit is further configured for transmitting said event to a server before said obtaining.

158. The system of claim 157, wherein said processing unit is further configured for converting said event into a well-defined event.

159. The system of claim 156, wherein said processing unit is further configured for receiving user instructions to configure said pre-determined rule.

160. The system of claim 156, wherein said processing unit is further configured for accessing a directory service for accessing information and operational preferences for said client.

161. The system of claim 160, wherein said processing unit is further configured for embedding state information into a persistent store on said client for said event.

162. The system of claim 161, wherein said processing unit is further configured for providing a notification service, said notification service allowing access to a notification dispatcher for said transmitting of said notifications.

163. The system of claim 162, wherein said processing unit is further configured for creating timers to control the duration of processing of said well-defined events.

164. The system of claim 156, wherein said processing unit is further configured for accessing a directory service for accessing information and operational preferences for said client.

165. The system of claim 156, wherein said processing unit is further configured for embedding state information into a persistent store on said client for said event.

166. The system of claim 156, wherein said processing unit is further configured for providing a notification service, said notification service allowing access to a notification dispatcher for said transmitting of said notifications.

167. The system of claim 156, wherein said processing unit is further configured for creating timers to control the duration of processing of said well-defined events.

168. The system of claim 157, wherein said processing unit is further configured for transmitting notifications as a result of the processing.

169. The system of claim 157, wherein said processing unit is further configured for:
receiving said event in said server from said client coupled thereto;
obtaining a pre-determined rule associated with said event; and
processing said event in accordance with said pre-determined rule.

170. The system of claim 169, wherein said processing unit is further configured for transmitting notifications as a result of the processing.

171. The system of claim 170, further comprising an executable script configured to provide customized service during said processing.

172. The system of claim 171, wherein said customized service provides access to a repository that facilitates querying and publishing of information.

173. The system of claim 172, wherein said information assists said systems in establishing connectivity therebetween.

174. The system of claim 172, wherein said customized service causes said executable script to embed state information into a persistent storage means for allowing said event to check state across more than one processing paths.

175. The system of claim 172, wherein said customized service further gives said executable script access to schedules to determine flow of processing of said event.

176. The system of claim 172, wherein said customized service further allows said executable script access to a notification dispatcher, said notification dispatcher transmitting said notifications.

177. The system of claim 176, wherein said processing unit is further configured means for receiving acknowledgement of said dispatched notification.

178. The system of claim 177, wherein said processing unit is further configured for assigning a priority level to said event in accordance with a pre-determined criterion.

179. The system of claim 178, wherein said processing unit is further configured for scheduling said event in accordance with said priority level.

180. The system of claim 157, wherein said processing unit is further configured for assigning a priority level to said well-defined event in accordance with a predetermined criterion.

181. The system of claim 180, wherein said processing unit is further configured for scheduling said well-defined event in accordance with said priority level.

182. A system for event communication among networks having a plurality of systems, comprising:
a. a memory;
b. a processing unit disposed in communication with said memory unit, wherein said processing unit is configured for:
receiving an event at a server, wherein the event is forwarded to said server from a client coupled thereto;
obtaining event handling scripts from a storage device associated with the server; and
creating a workflow process for processing said event.

183. The system of claim 182, wherein said processing unit is further configured for dispatching a notification based upon the processing of said event.

184. The system of claim 182, wherein said processing unit is further configured for accessing a repository for querying and publishing information between at least two of said plurality of systems.

185. The system of claim 182, wherein said processing unit is further configured for listening for determining presence of events at the server.

186. The system of claim 185, wherein said processing unit is further configured for loading a handling script for processing the subsection of said event.

187. The system of claim 186, wherein said processing unit is further configured for dispatching said processed events by one of electronic mail, paging devices, web browsers and instant messaging.

188. A system for event communication among networks having a plurality of systems, comprising:
a. a memory;
b. a processing unit disposed in communication with said memory unit, wherein said processing unit is configured for:
receiving an event at one of said plurality of networks;
retrieving an event handling script for processing said typed event; and
processing said event within said script engine in accordance with a predetermined handling script associated with said event.

189. The system of claim 188, wherein said processing unit is further configured for sending a notification of said event to a server coupled to said client, said notification providing monitoring information for said one of said plurality of networks.

190. The system of claim 189, wherein said processing unit is further configured for dispatching a notification in conformance with a predetermined dispatch policy.

191. The system of claim 190, wherein said processing unit is further configured for converting said event into a well-defined event, wherein said well-defined event facilitates processing of said event in said one of said plurality of networks.

192. The system of claim 191, wherein said processing unit is further configured for saving said well-defined event to a storage device.

193. A system for event communication among networks having a plurality of systems, comprising:
a. a memory;
b. a processing unit disposed in communication with said memory unit, wherein said processing unit is configured for:
receiving an event at a first network in said plurality of networks;
processing said event at said first network in accordance with a predetermined handling script associated with said event; and
dispatching a notification in conformance with a predetermined dispatch policy.

194. The system of claim 193, wherein said processing unit is further configured for sending a notification of said event to a server coupled to said client.

195. A system for event communication among networks having a plurality of systems, comprising:
a. a memory;
b. a processing unit disposed in communication with said memory unit, wherein said processing unit is configured for:
receiving an event at a first network in said plurality of networks;
transmitting said event to a second network in said plurality of networks;
processing said event at said second network in accordance with a predetermined handling script associated with said event; and
dispatching a notification in conformance with a predetermined dispatch policy.

196. A computer device comprising a computer readable medium having computer readable code means embodied therein for event communication among networks having a plurality of systems, said computer readable code means further comprising:
means for receiving an event signal in a client, said event signal transmitted by an event-generating entity coupled thereto;
means for obtaining a pre-determined rule associated with said event; and
means for processing said event in accordance with said pre-determined rule.

197. The computer readable code means of claim 196, further comprising means for transmitting said event to a server before said obtaining.

198. The computer readable code means of claim 196, further comprising means for converting said event into a well-defined event.

199. The computer readable code means of claim 196, further comprising means for receiving user instructions to configure said pre-determined rule.

200. The computer readable code means of claim 196, further comprising means for accessing a directory service for accessing information and operational preferences for said client.

201. The computer readable code means of claim 200, further comprising means for embedding state information into a persistent store on said client for said event.

202. The computer readable code means of claim 201, further comprising means for providing a notification service, said notification service allowing access to a notification dispatcher for said transmitting of said notifications.

203. The computer readable code means of claim 202, further comprising means for creating timers to control the duration of processing of said well-defined events.

204. The computer readable code means of claim 196, further comprising means for accessing a directory service for accessing information and operational preferences for said client.

205. The computer readable code means of claim 196, further comprising means for embedding state information into a persistent store on said client for said event.

206. The computer readable code means of claim 196, further comprising means for providing a notification service, said notification service allowing access to a notification dispatcher for said transmitting of said notifications.

207. The computer readable code means of claim 196, further comprising means for creating timers to control the duration of processing of said well-defined events.

208. The computer readable code means of claim 196, further comprising means for transmitting notifications as a result of the processing.

209. The computer readable code means of claim 197, further comprising:
means for receiving said event in said server from said client coupled thereto;
means for obtaining a predetermined rule associated with said event; and
means for processing said event in accordance with said predetermined rule.

210. The computer readable code means of claim 209, further comprising means for transmitting notifications as a result of the processing.

211. The computer readable code means of claim 210, further comprising an executable script configured to provide customized service during said processing.

212. The computer readable code means of claim 209, wherein said customized service provides access to a repository that facilitates querying and publishing of information.

213. The computer readable code means of claim 212, wherein said information assists said systems in establishing connectivity therebetween.

214. The computer readable code means of claim 213, wherein said customized service causes said executable script to embed state information into a persistent storage means for allowing said event to check state across more than one processing paths.

215. The computer readable code means of claim 213, wherein said customized service further gives said executable script access to schedules to determine flow of processing of said event.

216. The computer readable code means of claim 213, wherein said customized service further allows said executable script access to a notification dispatcher, said notification dispatcher transmitting said notifications.

217. The computer readable code means of claim 216, further comprising means for receiving acknowledgement of said dispatched notification.

218. The computer readable code means of claim 216, further comprising means for assigning a priority level to said event in accordance with a pre-determined criterion.

219. The computer readable code means of claim 218, further comprising means for scheduling said event in accordance with said priority level.

220. The computer readable code means of claim 196, further comprising means for assigning a priority level to said well-defined event in accordance with a predetermined criterion.

221. The computer readable code means of claim 220, further comprising means for scheduling said well-defined event in accordance with said priority level.

222. A computer device comprising a computer readable medium having computer readable code means embodied therein for event communication among networks having a plurality of systems, said computer readable code means further comprising:
means for receiving an event at a server, wherein the event is forwarded to said server from a client coupled thereto;
means for obtaining event handling scripts from a storage device associated with the server; and
means for creating a workflow process for processing said event.

223. The computer readable code means of claim 222, further comprising means for dispatching a notification based upon the processing of said event.

224. The computer readable code means of claim 223, further comprising means for accessing a repository for querying and publishing information between at least two of said plurality of systems.

225. The computer readable code means of claim 224, further comprising means for listening for determining presence of events at the server.

226. The computer readable code means of claim 225, further comprising means for loading a handling script for processing the subsection of said event.

227. The computer readable code means of claim 226, further comprising means for dispatching said processed events by one of electronic mail, paging devices, web browsers and instant messaging.

228. A computer device comprising a computer readable medium having computer readable code means embodied therein for event communication among networks having a plurality of systems, said computer readable code means further comprising:
means for receiving an event at one of said plurality of networks;
means for retrieving an event handling script for processing said typed event; and
means for processing said event within said script engine in accordance with a predetermined handling script associated with said event.

229. The computer readable code means of claim 228, further comprising means for sending a notification of said event to a server coupled to said client, said notification providing monitoring information for said one of said plurality of networks.

230. The computer readable code means of claim 229, further comprising means for dispatching a notification in conformance with a predetermined dispatch policy.

231. The computer readable code means of claim 230, further comprising means for converting said event in to a well-defined event, wherein said well-defined event facilitates processing of said event in said one of said plurality of networks.

232. The computer readable code means of claim 231, further comprising means for saving said well-defined event to a repository.

233. A computer device comprising a computer readable medium having computer readable code means embodied therein for event communication among networks having a plurality of systems, said computer readable code means further comprising:
means for receiving an event at a first network in said plurality of networks;
means for processing said event at said first network in accordance with a predetermined handling script associated with said event; and
means for dispatching a notification in conformance with a predetermined dispatch policy.

234. The computer readable code means of claim 233, further comprising means for sending a notification of said event to a server coupled to said client.

235. A computer device comprising a computer readable medium having computer readable code means embodied therein for event communication among networks having a plurality of systems, said computer readable code means further comprising:
means for receiving an event at a first network in said plurality of networks;
means for transmitting said event to a second network in said plurality of networks;
means for processing said event at said second network in accordance with a predetermined handling script associated with said event; and
means for dispatching a notification in conformance with a predetermined dispatch policy.
